(19) United States
(12) Patent Application Publication
(10) Pub. No.: US 2007/0021109 A1
(43) Pub. Date: Jan. 25, 2007

(54) Remote disabling of an article of manufacture

(76) Inventor: Samuel N. Zellner, Dunwoody, GA (US)

Correspondence Address: SCOTT P. ZIMMERMAN, PLLC, PO BOX 3822, CARY, NC, 27519, US

(21) Appl. No.: 11/186,616

(22) Filed: Jul. 21, 2005

(51) Int. Cl. H04M 3/00

(52) U.S. Cl. 455/418

(57) ABSTRACT

Methods, devices, and computer program products describe remotely disabling an article of manufacture. One such device includes a processor communicating with a display device. The processor sends a first registration message to register with a first service provider. If the processor attempts a second registration with a second service provider, the processor produces a prompt on the display to fulfill a service agreement to the first service provider. The processor receives a response to the prompt. If the response fulfills the service agreement, then the processor permits registration with the second service provider. If, however, the response fails to fulfill the service agreement, then the processor disables a function of the article of manufacture.

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

This application generally relates to communications and, more particularly, to selective communications, to condition responsive systems, to composite signaling, to service triggers, and to radiotelephone systems.

Subsidization of electronic devices, appliances, and other articles of manufacture is coming. The term “subsidization” implies a subsidy is provided for the article of manufacture. Already the communications industry subsidizes a mobile phone and other wireless devices in exchange for a service contract. The user of the mobile phone (e.g., the “subscriber”) receives a free, or nearly free, phone in exchange for a service commitment. Some people within the communications sector foresee subsidization spreading to any article of manufacture that requires communications service. As the latest washers, dryers, refrigerators, televisions, and even vehicles have communications capabilities, those articles of manufacture will require network access to communications networks. It may be inevitable that the purchase price for such networked articles of manufacture is subsidized in exchange for a service agreement.

Subsidization usually includes an exclusive service agreement. An exclusive service agreement may be required in exchange for the subsidy. The service agreement may require periodic payments in exchange for the subsidized purchase price, and the service agreement may require exclusivity of service providers. That is, if a service provider subsidizes the purchase price for the article of manufacture, then the service provide will require that the user exclusively use the service provider's services. If, for example, the service provider provides network access to a communications network, then the service provider may require an exclusive agreement whereby the article of manufacture only utilizes that communications service provider. Any other communications service provider is excluded during the contractual term. If the service provider provides a repair service (such as a maintenance contract), then the user must exclusively utilize the repair service provider. If the service provider provides food, fuel, electricity, or other consumables, then the service provider may require an exclusive service agreement in exchange for the subsidy. Whatever the service, an exclusive service agreement may be required in exchange for the subsidy provided by the service provider.

Enforcing the exclusive service agreement, however, is a problem. When the service provider subsidizes a service, the exclusive service agreement is required to ensure the subsidy is recouped. If the user/subscriber reneges on the service agreement, and switches to a competing service provider, the subsidizing service provider incurs a substantial loss. What is needed, then, are methods, systems, and products that disable an article of manufacture when a subscriber defaults on a service agreement.

### SUMMARY

According to exemplary embodiments, methods, systems, and devices are disclosed that disable an article of manufacture. If the article of manufacture is subsidized, then an exclusive service agreement may prohibit competing services from another service provider. The exemplary embodiments detect when the article of manufacture registers with any service provider. As the article of manufacture registers with each service provider, a profile is created describing that service. The profile may include details of any service agreement, such as whether the service agreement is an exclusive arrangement. If the article of manufacture then attempts to register with a competing service provider, the exemplary embodiments remind the user/subscriber of the exclusive agreement. The user/subscriber can affirm the exclusive service agreement, or a payment may be made to fulfill the service agreement. If a payment is made, then the user/subscriber may be released from the service agreement. If no affirmation is made, and/or if no payment is made, then the article of manufacture is disabled. Only the subsidizing service provider may reactivate or re-enable the article of manufacture.

The article of manufacture may be any electrical or electromechanical apparatus. The article of manufacture is preferably processor-controlled, thus capable of disabling the article of manufacture, as the following paragraphs will explain. The article of manufacture may be any television, appliance (e.g., washing machine, dryer, oven, or refrigerator), or audio/video componetry. The article of manufacture, however, may include vehicular electronics, such as engine/electronic controllers, chassis controllers, or communications controllers. The article of manufacture may also include computers and communications devices, as later paragraphs will explain.

According to exemplary embodiments, a device is disclosed that remotely disables an article of manufacture. The device includes a processor communicating with a display device. The processor sends a first registration message to register with a first service provider. If the processor attempts a second registration with a second service provider, the processor produces a prompt on the display to fulfill a contractual obligation to the first service provider. The processor receives a response to the prompt. If the response fulfills the contractual obligation, then the processor permits registration with the second service provider. If, however, the response fails to fulfill the contractual obligation, then the processor disables a function of the article of manufacture.

According to more exemplary embodiments, a method is disclosed of remotely disabling an article of manufacture. The method sends a first registration message to a first service provider. If a second registration is attempted with a second service provider, then a prompt is presented to fulfill a contractual obligation to the first service provider. A response is received to the prompt. If the response fulfills the contractual obligation, then the method permits registration with the second service provider. If, however, the response fails to fulfill the contractual obligation, then the method disables a function of the article of manufacture.

According to even more exemplary embodiments, a computer program product is disclosed for remotely disabling an article of manufacture. The computer program product comprises a computer-readable medium storing computer code. The computer code performs or causes a first registration message to be sent to a first service provider. If the article of manufacture attempts a second registration with a second service provider, then the computer code prompts a user to fulfill a contractual obligation to the first service provider. A response to the prompt is received. If the response fulfills the contractual obligation, then computer code permits registration with the second service provider. If, however, the response fails to fulfill the contractual obligation, then computer code causes a function of the article of manufacture to be disabled.

Other systems, methods, and/or computer program products according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### DESCRIPTION OF THE DRAWINGS

These and other features, aspects, and advantages of the exemplary embodiments are better understood when the following Detailed Description is read with reference to the accompanying drawings, wherein:

FIG. 1 is a schematic illustrating registration of an article of manufacture, according to an exemplary embodiment;

FIG. 2 is a schematic illustrating use of a profile of service agreements, according to exemplary embodiments;

FIG. 3 is a schematic illustrating use of a query for service agreements, according to exemplary embodiments;

FIG. 4 is a schematic illustrating use of a prompt, according to exemplary embodiments;

FIG. 5 is a schematic illustrating disabling of an article of manufacture, according to exemplary embodiments;

FIG. 6 is a schematic illustrating use of a registration alert, according to exemplary embodiments;

FIG. 7 is a schematic illustrating use of a disabling message, according to exemplary embodiments;

FIG. 8 is a schematic further illustrating disablement of the article of manufacture, according to more exemplary embodiments;

FIG. 9 depicts an exemplary article of manufacture in detail;

FIGS. 10 and 11 are schematics further illustrating the article of manufacture as various types of communications devices, according to exemplary embodiments;

FIG. 12 is a block diagram illustrating the article of manufacture as a television, according to exemplary embodiments;

FIG. 13 is another block diagram illustrating the article of manufacture as any electromechanical device, according to exemplary embodiments; and

FIGS. 14 and 15 are flowcharts illustrating a method of remotely disabling an article of manufacture, according to exemplary embodiments.

### DETAILED DESCRIPTION

Exemplary embodiments will now be described more fully hereinafter with reference to the accompanying drawings, in which exemplary embodiments are shown. The exemplary embodiments, however, may be embodied in many different forms and should not be construed as limited to the embodiments set forth herein. These embodiments are provided so that this disclosure will be thorough and complete and will fully convey the scope of the exemplary embodiments to those of ordinary skill in the art. Moreover, all statements herein reciting the exemplary embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying the exemplary embodiments. The functions of the various elements shown in the figures may be provided through the use of dedicated hardware as well as hardware capable of executing associated software. Those of ordinary skill in the art further understand that exemplary hardware, software, processes, methods, and/or operating systems described herein are for illustrative purposes and, thus, are not intended to be limited to any particular named manufacturer.

Exemplary embodiments describe methods, systems, and devices that disable an article of manufacture. If the article of manufacture is subsidized, then an exclusive service agreement may prohibit competing services from another service provider. The exemplary embodiments detect when the article of manufacture registers with any service provider. As the article of manufacture registers with each service provider, a profile is created describing that service. The profile may include details of any service agreement, such as whether the service agreement is an exclusive arrangement. If the article of manufacture then attempts to register with a competing service provider, the exemplary embodiments remind the user/subscriber of the exclusive agreement. The user/subscriber can affirm the exclusive service agreement, or a payment may be made to fulfill the service agreement. If a payment is made, then the user/subscriber may be released from the service agreement. If no affirmation is made, and/or if no payment is made, then the article of manufacture may be disabled. According to exemplary embodiment, only the subsidizing service provider may reactivate or re-enable the article of manufacture.

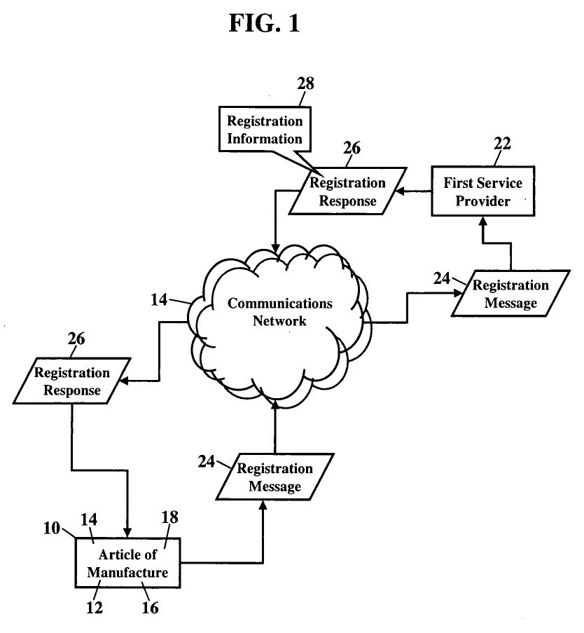

FIG. 1 is a schematic illustrating registration of an article of manufacture, according to an exemplary embodiment. An article 10 of manufacture is generically shown in FIG. 1. It will be appreciated, however, that the article 10 of manufacture may be any electrical or electromechanical apparatus, such as a communications device, a television, an appliance (e.g., washing machine, dryer, oven, or refrigerator), audio/video componetry, vehicular electronics, or any other article of manufacture, as later paragraphs will explain. The article 10 of manufacture includes a processor 12 communicating with an audio/video device 14 and with memory 16. The processor 12, however, may be remotely located from the article 10 of manufacture, such as remotely located at a server, attached to the article 10 of manufacture, or communicated with the article 10 of manufacture. The processor 12 may control any functions of the article 10 of manufacture, such as operations or communications. The article 10 of manufacture also includes a communications interface 18 to a communications network 20. The communications interface 18 allows the article 10 of manufacture to send and receive information and/or messages via the communications network 20.

According to an exemplary embodiment, the article 10 of manufacture registers with a first service provider 22. The first service provider 22 provides some service to the article 10 of manufacture, and the first service provider 22 desires enrollment or registration for this service. The first service provider 22, for example, may be a communications service provider, and the first service provider 22 provides network access to the communications network 20. The first service provider 22 desires that the article 10 of manufacture register to receive network access. The first service provider 22, however, could provide repair service to the article 10 of manufacture, and the first service provider 22 desires registration for the repair service. The first service provider 22 may provide a supply service to the article 10 of manufacture, such as providing consumables (e.g., oil/lubricants, fuel, soap, or electricity) to the article 10 of manufacture. The first service provider 22 desires registration when supplying these consumables. Registration may also be desired to provide software/hardware updates to the article 10 of manufacture. Registration may be desired for warranty services, recalls, service campaigns, or marketing programs.

Whatever the first service provider 22 provides, registration is desired. A registration message 24 is routed from the article 10 of manufacture to the first service provider 22. The registration message 24 is communicated to the first service provider 22 via the communications network 20. The registration message 24 requests or confirms registration with the first service provider 22. The registration message 24 may originate from the article 10 of manufacture, or the registration message 24 may respond to prompts, queries, or messages originating from the first service provider 22 (not shown for simplicity). When the first service provider 22 receives the registration message 24, the first service provider 22 registers the article 10 of manufacture for the service provided. The first service provider 22 may send a registration response 26 to the article 10 of manufacture, and the registration response 26 confirms registration.

A service agreement may be required for the service. The first service provider 22 may require a service agreement or contractual obligation to provide the service. The service agreement may require periodic payments for the service, and/or the service agreement may require exclusivity of service providers. If, for example, the first service provider 22 provides network access to the communications network 20, the first service provider 22 may require an exclusive agreement whereby the article 10 of manufacture only utilizes the first service provider 22 for access service. Any other network access provider is excluded during the contractual term. If the first service provider 22 provides repair service to the article 10 of manufacture (such as a maintenance contract), a user of the article 10 of manufacture may pay a weekly/monthly/yearly fee for this service. If the article 10 of manufacture consumes fuel, lubricants, or electricity, the first service provider 22, likewise, may require a periodic payment for delivering/providing these consumables. The first service provider 22 may subsidize the article 10 of manufacture, such as providing a “free” wireless communications device, set-top box, or refrigerator, in exchange for a service agreement. The first service provider 22 may subsidize the article 10 of manufacture by requiring an exclusive commitment to provide consumables. Again, whatever the service, a service agreement may be required for the service.

As further illustrated in FIG. 1, the registration response 26 includes registration information 28. According to an exemplary embodiment, this registration information describes various details concerning the first service provider 22, the registration, the article 10 of manufacture, and even the service agreement.

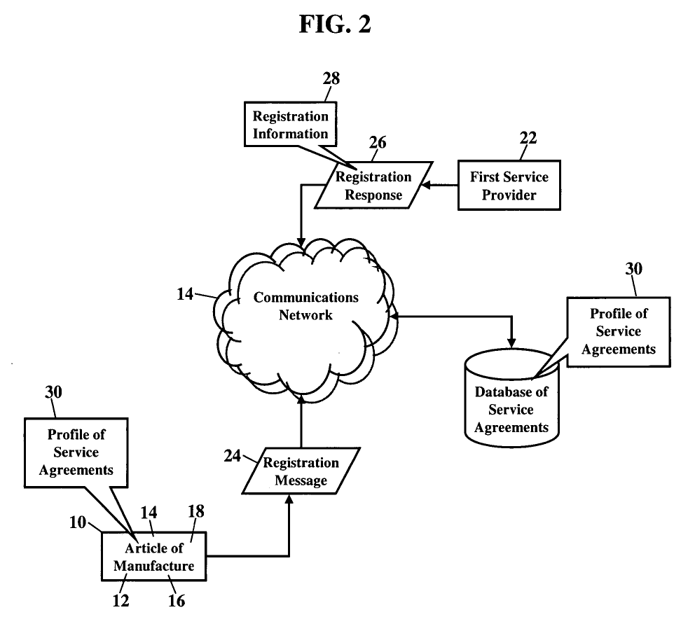

FIG. 2 illustrates use of a profile 30 of service agreements, according to exemplary embodiments. When the processor 12 receives the registration response 26, the processor 12 populates the profile 30 with the registration information 28. The profile 30 of service agreements, for example, stores information describing each service agreement with a service provider. The profile 30 of service agreements may describe one or more obligations between the service provider and a user/subscriber of the article 10 of manufacture. Suppose, for example, the first service provider 22 has an exclusive agreement to provide network access to the article 10 of manufacture. When the article 10 of manufacture registers for this exclusive network access, the first service provider 22 communicates the registration response 26 to the article 10 of manufacture. The registration response 26 includes the registration information 28 that configures the profile 30 of service agreements. The profile 30 of service agreements is configured with a flag, attribute, or other information that indicates the first service provider 22 exclusively provides network access to the article 10 of manufacture. Whatever service a service provider provides, the profile 30 of service agreements describes whether that corresponding service provider has an exclusive service agreement. The profile 30 of service agreements may be locally stored in the memory 16 at the article 10 of manufacture. The profile 30 of service agreements, however, may be remotely stored and accessible via the communications network 20.

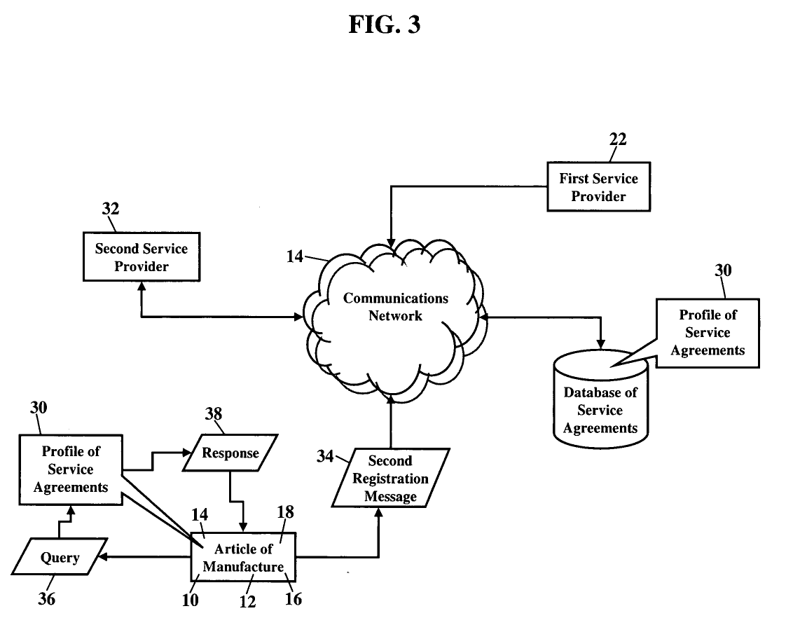

FIG. 3 is a schematic illustrating use of a query for service agreements, according to exemplary embodiments. The first service provider 22, as earlier explained, may require a service agreement or contractual obligation to provide the service. If the article 10 of manufacture attempts to register with a second service provider 32, the processor 12 determines whether that attempted registration conflicts with or violates any service agreement with the first service provider 22. If the article 10 of manufacture attempts to send a second registration message 34 to the second service provider 32, the processor 12 determines whether that attempted second registration conflicts or violates any exclusive service agreement with the first service provider 22.

As FIG. 3 illustrates, the processor 12 queries the profile 30 of service agreements. The profile 30 of service agreements stores information for each service provider. As the article 10 of manufacture registers with each service provider, the profile 30 of service agreements stores information describing that registration. The processor 12 queries the profile 30 of service agreements to determine whether that attempted second registration conflicts or violates with any exclusive service agreement with another service provider. A query 36 includes information describing the attempted second registration, such as what type of service is being registered. (If the profile 30 of service agreements is remotely stored, then the query 36 communicates via the communications network 20.)

The profile 30 of service agreements receives the query 36 and checks the registration information. If the first service provider 22 exclusively provides a service, then the profile 30 of service agreements has some flag, attribute, or other information that indicates this exclusivity. Any other attempted registration for the same or similar service would conflict with this exclusivity. A response 38 is generated that includes information that describes whether the attempted second registration conflicts with the first service provider's exclusive service agreement. The response 38, for example, may indicate that the attempted second registration is for network access, and the profile 30 of service agreements already contains an entry indicating an exclusive service agreement for network access with the first service provider 22. The response 38, then, may indicate that the attempted second registration be declined. The processor 12 receives the response 38 and acts accordingly. If the response 38 indicates the attempted second registration does not conflict with another service provider's exclusive agreement, then the processor 12 permits the second registration.

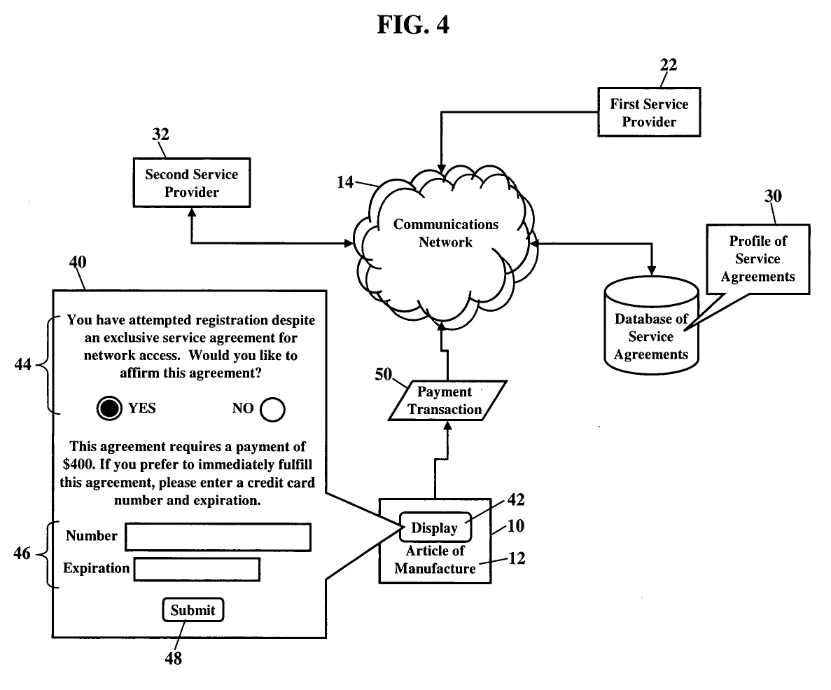

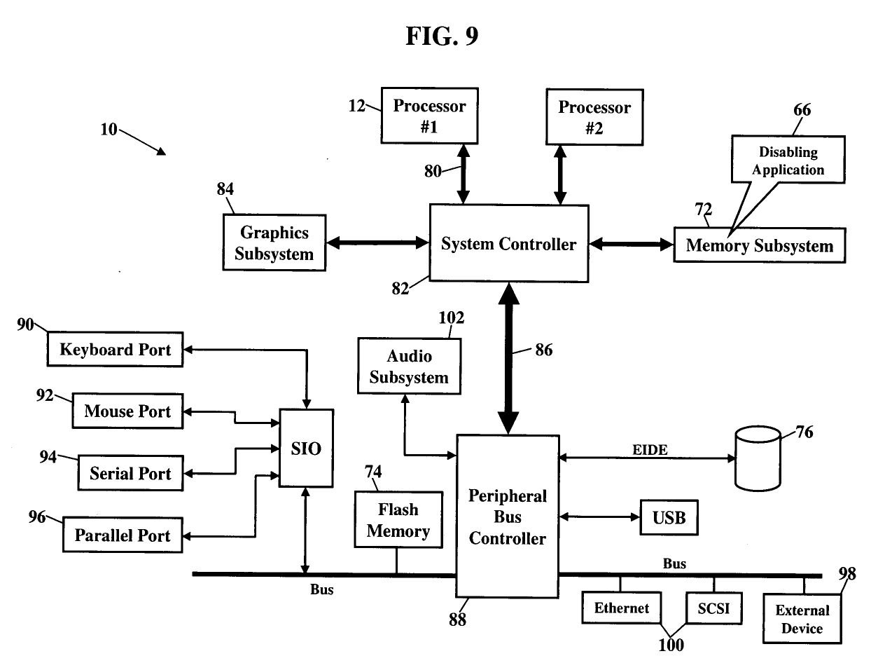

FIG. 4 is a schematic illustrating use of a prompt 40, according to exemplary embodiments. When the response (shown as reference numeral 38 in FIG. 3) indicates that the attempted second registration conflicts with another service provider's exclusive agreement, then the processor 12 generates a prompt to remind a user of the exclusive service agreement. The processor 12 audibly and/or visually presents a prompt or other notification of the exclusive service agreement. The prompt 40 is audibly and/or visually presented via a prompting device connected to the processor 12 via an interface (such as via a peripheral bus controller for a video display unit and/or for an audio subsystem, as explained and shown in FIG. 9). In the embodiment show in FIG. 4, the processor 12 communicates with a display 42 to cause a prompt to be displayed. The display 12 may be included within the article 10 or may be attached to it. The prompt 40 reminds the user of the exclusive service agreement with the first service provider 22. The prompt 40 may ask or require that the user affirm 44 the exclusive service agreement.

The prompt 40 may also prompt the user to fulfill the exclusive service agreement. That is, if the user fulfills any or all obligations and/or provisions of the exclusive service agreement, then the processor 12 could permit the second registration. Suppose, for example, the first service provider 22 exclusively provides network access for a monthly payment of $20. The exclusive service agreement has a term of two (2) years, thus requiring twenty four (24) monthly payments. If the user truly desires to register with another network access service provider (e.g., the second service provider 26), then the prompt 40 may also ask the user to make each unfulfilled monthly payment. If twenty (20) months remain on the exclusive service agreement, then the prompt 40 would require a payment of $400 ($20 per month for 20 months). The remaining or unfulfilled terms of the service agreement (and/or any remaining financial obligations) could be included in the response received from the profile of service agreements (shown, respectively, as reference numerals 38 and 30 in FIG. 2). The prompt 40 could require immediate payment to fulfill the service agreement. The prompt 40 could include data fields 46 for credit card account number and expiration, bank account/routing information, or other electronic commerce payment information. Once the user affirms the service agreement, or enters payment information, the user submits a response. The user, for example, would click or otherwise tactilely select a “Submit” graphical indicator or action button 48. The user could also verbally or audibly indicate their response.

The processor 12 receives the response and determines the user's desired action. If the user affirms the service agreement, then the processor 12 denies or declines the attempted second registration. The user's affirmation indicates the user's desire to maintain the exclusive service agreement with the first service provider 22. If, however, the user enters payment information, then the processor 12 formulates one or more transaction messages 50 to communicate and to process this payment information, as is known to one of ordinary skill in the art. If the payment is authorized, then the user's response fulfills the service agreement, and the processor 12 permits registration with the second service provider. If, however, the response fails to fulfill the service agreement, then the processor 12 takes actions that disable one or more functions of the article 12 of manufacture. If, for example, the user's banking institution denies/declines a credit card payment or debit transaction, then the user has not fulfilled the service agreement.

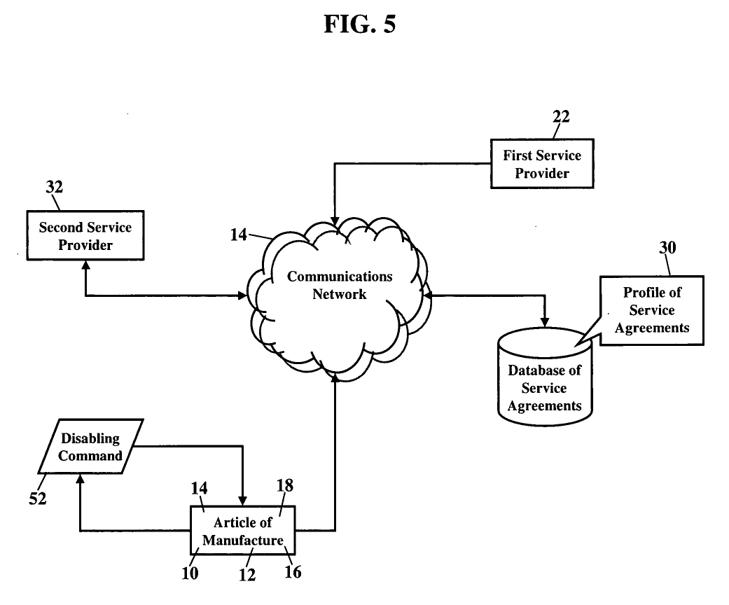

FIG. 5 is a schematic illustrating disabling of the article 12 of manufacture, according to exemplary embodiments. If the user's response fails to fulfill the service agreement, then the processor 12 disables one or more functions of the article 12 of manufacture. If the user enters an exclusive service agreement, but later fails to honor that service agreement, then the processor 12 disables one, some, or all operations of the article 10 of manufacture. As FIG. 5 illustrates, the processor 12 issues a disabling command 52. The disabling command 52 instructs any component and/or interface of the article 10 of manufacture to suspend, idle, shutdown, or cease operation. If the article 10 of manufacture, for example, is a wireless communications device, then the processor 12 could disable a transceiver, memory, keypad, sub-processor, or other component. If the article 10 of manufacture is a television, then the processor 12 could disable a display, encoder/decoder, transceiver, hard drive, or even remote control. If the article 10 of manufacture is a washer or dryer, then the processor 12 could disable a motor control unit or logic interface. If the article 10 of manufacture is a refrigerator, then the processor 12 could disable a compressor or control unit. Whatever the article 10 of manufacture, the processor 12 may disable any function.

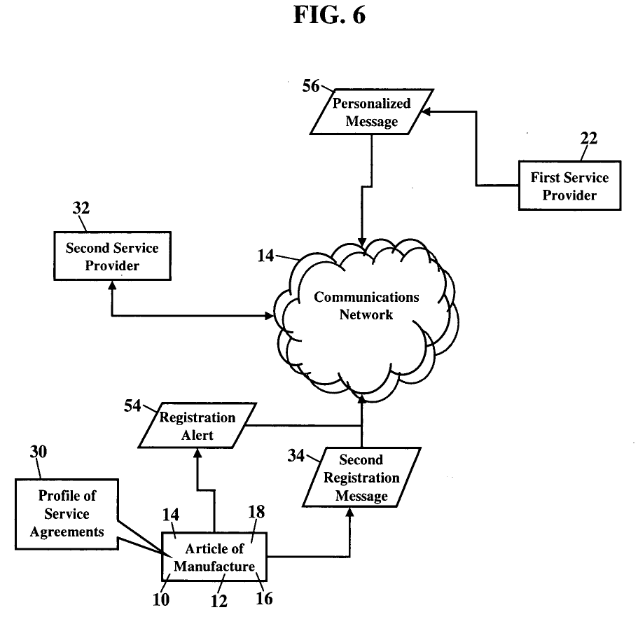

FIG. 6 is a schematic illustrating use of a registration alert 54, according to exemplary embodiments. Here the processor 12 communicates the registration alert 54 to the first service provider 22. The registration alert 54 is communicated to the first service provider 22 via the communications network 20. The registration alert 54 notifies the first service provider 22 of the user's/subscriber's attempted registration with another service provider (such as the second service provider 32), e.g., another service provider that provides the same or similar service. The registration alert 54 may also notify the first service provider 32 of the user's/subscriber's refusal to honor the exclusive service agreement.

The first service provider 22 now has a number of options. The registration alert 54 alerts the first service provider 22 to the attempted registration with another service provider. The first service provider 22 may respond with a personalized message 56 that invites or encourages the user/subscriber to uphold the service agreement. The personalized message 56 may include encouraging statements or even promotions that entice the user/subscriber. The promotions may include electronic, redeemable coupons for products or services. The personalized message 56 may even include addendums or extensions to the service agreement. The personalized message 56 is an inexpensive and immediate effort to maintain the service agreement. The first service provider 22 may additionally or alternatively make phone calls, pages, faxes, or other electronic communications that attempt to maintain the service agreement. The first service provider 22 may even instruct a local representative to contact the user/subscriber and attempt reconciliation.

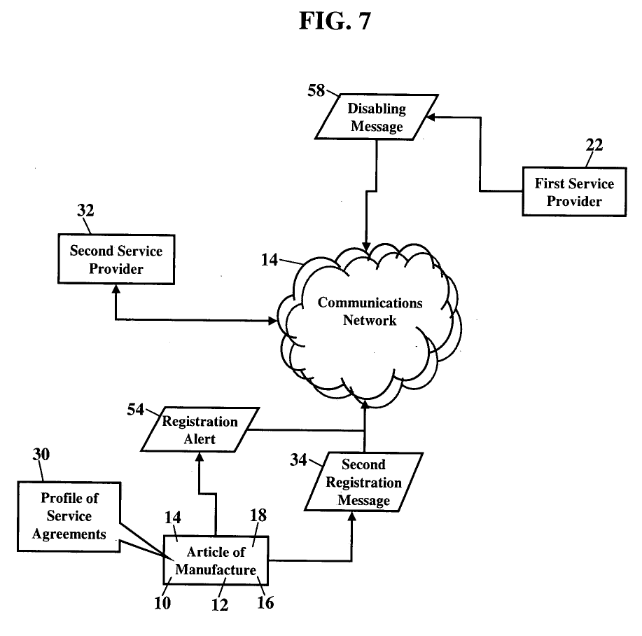

FIG. 7 is a schematic illustrating use of a disabling message 58, according to exemplary embodiments. When the processor 12 communicates the registration alert 54 to the first service provider 22, the registration alert 54 notifies the first service provider 22 of the user's/subscriber's attempted registration with another service provider. The registration alert 54 may also notify the first service provider 22 of the user's/subscriber's refusal to honor the exclusive service agreement. Here, then, the first service provider 22 sends the disabling message 58. The disabling message 58 is routed to a communications address associated with the article 10 of manufacture. The disabling message 58 instructs the processor 12 to disable one, some, or all functions of the article 10 of manufacture. The disabling message 58 may be sent in response to a failure of the personalized message (shown as reference numeral 56 in FIG. 6) to entice the user/subscriber. The disabling message 58 may be unilaterally sent whenever the first service provider 22 is notified of the user's/subscriber's attempted registration with another service provider. The disabling message 58 may include some information that identifies what function is to be disabled. The processor 12 may also execute instructions that automatically specify what function is disabled upon receipt of the disabling message 58.

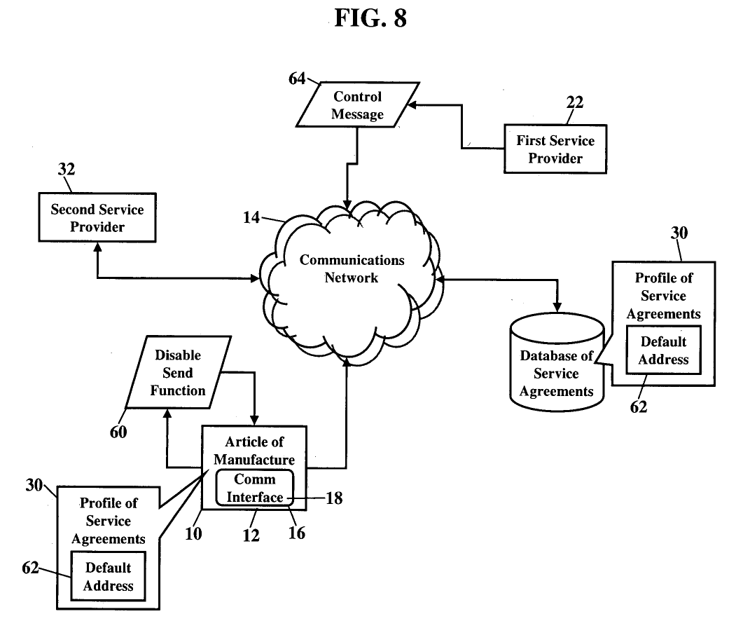

FIG. 8 is a schematic further illustrating disablement of the article 10 of manufacture, according to more exemplary embodiments. Whether the processor 12 unilaterally decides to disable the article 10 of manufacture (as illustrated in FIG. 5), or whether the processor 12 is instructed (such as via the disabling message 58 shown in FIG. 7), here the processor 12 restricts the communications capabilities of the article 10 of manufacture. The processor 12 commands the communications interface 18 (shown as “Comm Interface”) to only permit communications to and/or from the first service provider 22. That is, the processor 12 may disable a send function 60 to all communications addresses except those communications addresses associated with the first service provider 22. The profile 30 of service agreements, in fact, may contain a default communications address 62 to only which communications may be sent and received. If the user/subscriber defaults on the service agreement, the first service provider 22 may designate that the article 10 of manufacture only communicate with the first service provider. Because the article 10 of manufacture only communicates with the first service provider 22, the first service provider 22 may send control messages 64 that entirely specify how the article 10 operates during default.

FIG. 9 illustrates an article 10 of manufacture in detail according to exemplary embodiments. The article 10 of manufacture includes a disabling application 66, which is a computer program that includes computer-readable instructions for disabling the article 10 according to exemplary embodiments. The disabling application 66 operates within a system memory device. The disabling application 66, for example, is shown residing in a memory subsystem 72. The disabling application 66, however, could also reside in flash memory 74 or peripheral storage device 76. The article 10 of manufacture also has one or more of the processors 12 executing an operating system. The operating system, as is well known, has a set of instructions that control the internal functions of the article 10 of manufacture. A system bus 80 communicates signals, such as data signals, control signals, and address signals, between the processor 12 and a system controller 82 (typically called a “Northbridge”). The system controller 82 provides a bridging function between the processor 12, a graphics subsystem 84, the memory subsystem 72, and a PCI (Peripheral Controller Interface) bus 86. The PCI bus 86 is controlled by a Peripheral Bus Controller 88. The Peripheral Bus Controller 88 (typically called a “Southbridge”) is an integrated circuit that serves as an input/output hub for various peripheral ports. These peripheral ports could include, for example, a keyboard port 90, a mouse port 92, a serial port 94, and/or a parallel port 96 for a video display unit, one or more external device ports 98, and networking ports 100 (such as USB, SCSI, or Ethernet). The Peripheral Bus Controller 88 could also include an audio subsystem 102. Those of ordinary skill in the art understand that the program, processes, methods, and systems described herein are not limited to any particular manufacturer or hardware.

One example of the processor 12 is a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of X86 and P86 microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). Those skilled in the art further understand that the program, processes, methods, and systems described herein are not limited to any particular manufacturer's processor.

According to an exemplary embodiment, the WINDOWS® (WINDOWS® is a registered trademark of Microsoft Corporation, One Microsoft Way, Redmond Wash. 98052-6399, 425.882.8080, www.Microsoft.com) operating system may be used. Other operating systems, however, are also suitable. Such other operating systems would include the UNIX® operating system (UNIX® is a registered trademark of the Open Source Group, www.opensource.org), the UNIX-based Linux operating system, WINDOWS NT®, and Mac® OS (Mac® is a registered trademark of Apple Computer, Inc., 1 Infinite Loop, Cupertino, Calif. 95014, 408.996.1010, www.apple.com). Those of ordinary skill in the art again understand that the program, processes, methods, and systems described herein are not limited to any particular operating system.

The system memory device (shown as memory subsystem 72, flash memory 74, or peripheral storage device 76) may also contain an application program. The application program cooperates with the operating system and with a video display unit (via the serial port 94 and/or the parallel port 96) to provide a Graphical User Interface (GUI). The Graphical User Interface typically includes a combination of signals communicated along the keyboard port 90 and the mouse port 92. The Graphical User Interface provides a convenient visual and/or audible interface with a user of the article 10 of manufacture.

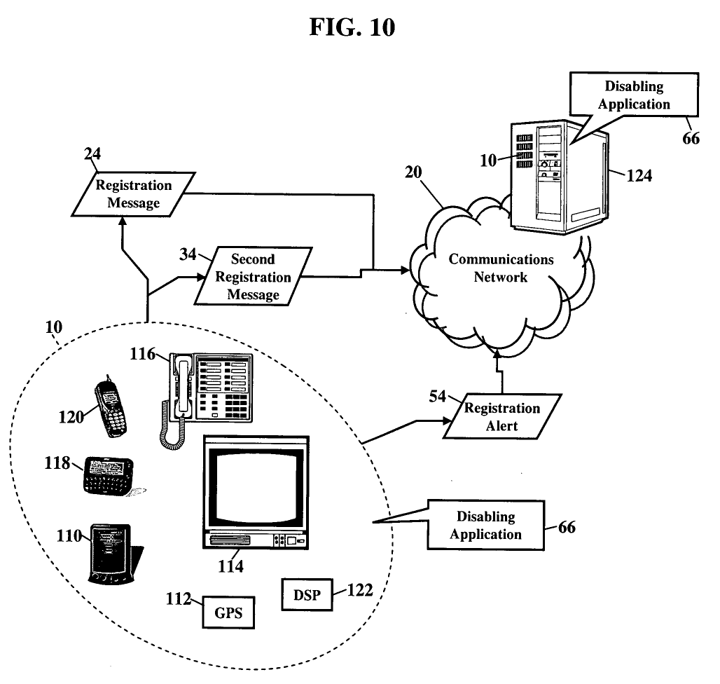

FIG. 10 is a schematic further illustrating the article 10 of manufacture as various types of communications devices for sending, receiving, and/or processing messages (such as the registration message 24, the second registration message 34, and the registration alert 54). FIG. 10, for example, illustrates that the disabling application 66 may entirely or partially operate within a personal digital assistant (PDA) 110, a Global Positioning System (GPS) device 112, an interactive television 114, an Internet Protocol (IP) phone 116, a pager 118, a cellular/satellite phone 120, or any computer system and/or communications device utilizing a digital signal processor (DSP) 122. The communications device may also include watches, radios, vehicle electronics, clocks, printers, gateways, and other apparatuses and systems. FIG. 10 also illustrates that the article 10 of manufacture may be a computer server 124, and the disabling application 66 may entirely or partially operate within the computer server 124 communicating via the communications network 20.

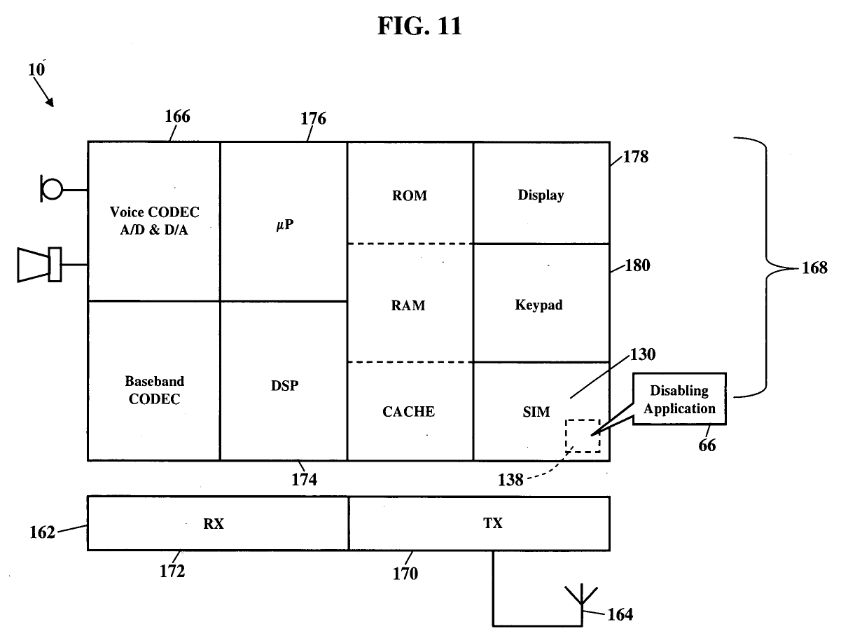

FIG. 11 is a schematic further illustrating the article 10 of manufacture as another communications device storing the disabling application 66. Here the article 10 of manufacture comprises a radio transceiver unit 162, an antenna 164, a digital baseband chipset 166, and a man/machine interface (MMI) 168. The transceiver unit 162 includes transmitter circuitry 170 and receiver circuitry 172 for receiving and transmitting signals. The transceiver unit 162 couples to the antenna 164 for converting electrical current to and from electromagnetic waves. The digital baseband chipset 166 contains a digital signal processor (DSP) 174 and performs signal processing functions for audio (voice) signals and RF signals. As FIG. 11 shows, the digital baseband chipset 166 may also include an on-board microprocessor 176 that interacts with the man/machine interface (MMI) 168. The man/machine interface (MMI) 168 may comprise a display device 178, a keypad 180, and a Subscriber Identity Module 130. The on-board microprocessor 176 performs GSM protocol functions and control functions for the radio circuitry 170 and 172, for the display device 178, and for the keypad 180. The on-board microprocessor 176 may also interface with the Subscriber Identity Module 130 and with the disabling application 66 residing in the memory module 138 of the Subscriber Identity Module 130. Those skilled in the art will appreciate that there may be many suitable architectural configurations for the elements of the communications device. If the reader desires a more detailed explanation, the reader is invited to consult the following sources: LAWRENCE HARTE et al., GSM SUPERPHONES 105-120 (1999); SIEGMUND REDL et al., GSM AND PERSONAL COMMUNICATIONS HANDBOOK 389-474 (1998); and JOACHIIM TISAL, GSM CuELLULAR RADIO TELEPHONY 99-130 (1997), with each incorporated herein by reference.

The disabling application 66 may be utilized regardless of the signaling standard. As those of ordinary skill in the art recognize, FIG. 11 illustrates a Global System for Mobile (GSM) communications device. That is, the communications device utilizes the Global System for Mobile (GSM) communications signaling standard. Those of ordinary skill in the art, however, also recognize that the disabling application 66 is equally applicable to any communications device utilizing the Time Division Multiple Access signaling standard, the Code Division Multiple Access signaling standard, the “dual-mode” GSM-ANSI Interoperability Team (GAIT) signaling standard, or any variant of the GSM/CDMA/TDMA signaling standard.

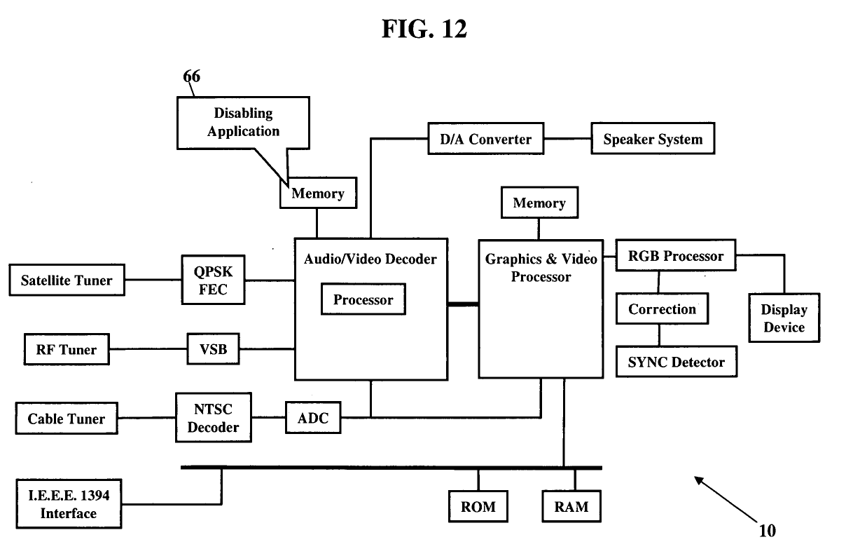

FIG. 12 is another block diagram of the article 10 of manufacture, according to yet more of the exemplary embodiments. Here the article 10 of manufacture is shown as a digital high definition television (HDTV) system, yet the concepts described herein are applicable to any television design. The concepts, for example, are applicable to analog circuitry, digital circuitry, analog signals, and/or or digital signals. The television may include an encoder/decoder, such as an embedded set-top box. The term “television,” however, may encompass a stand-alone set-top box that is a separate component from the television. The television may also utilize any display device technology, such as a cathode-ray, a liquid crystal, a diode, digital micromirror, light processor, or plasma. The disabling application 66 may be stored in any memory location or device in the television. FIG. 12, though, is only a simplified block diagram. The operating and engineering principles are already known in the art and will not be repeated here. If, however, the reader desires more information on the television, the reader is directed to the following sources: MICHEAL ROBIN & MICHEL POULIN, DIGITAL TELEVISION FUNDAMENTALS (2000); JERRY WHITAKER AND BLAIR BENSON, VIDEO AND TELEVISION ENGINEERING (2003); JERRY WHITAKER, DTV HANDBOOK (2001); JERRY WHITAKER, DTV: THE REVOLUTION IN ELECTRONIC IMAGING (1998); and EDWARD M. SCHWALB, ITV HANDBOOK: TECHNOLOGIES AND STANDARDS (2004), with each incorporated herein by reference.

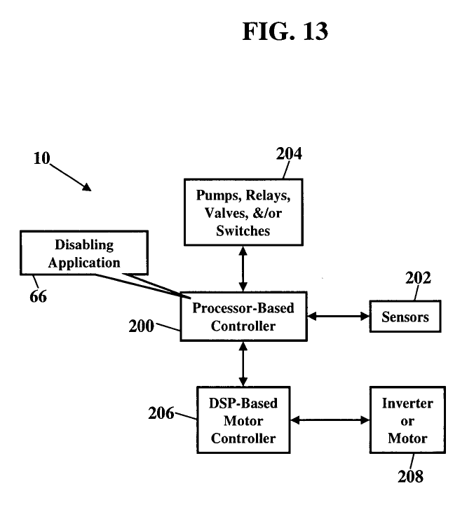

FIG. 13 is another block diagram of the article 10 of manufacture, according to yet more of the exemplary embodiments. Here the article 10 of manufacture is any electromechanical device, such as a washing machine, clothes dryer, or refrigerator. The article 10 of manufacture has a processor-based electronic controller 200 that controls or commands one or more sensors 202. These sensors 202 may monitor, detect, and/or report temperature, humidity, turbidity, pressure, water levels, refrigerant level, speed, distance, or acceleration. The sensors 202 may also measure, monitor, and/or report yaw, pitch, roll, angle, altitude, longitude, or latitude. The sensors 202 may measure, monitor, and report barometric pressure, oxygen (O₂) level, carbon monoxide (CO) level, resistance, current, or voltage. Whatever the sensors 202 monitor, the processor-based electronic controller 200 then uses those measurements to command and control electrical and electromechanical devices 204, such as pumps, valves, relays, switches, transistors, and electronic circuitry. The processor-based electronic controller 200 may even receive inputs from the electrical and electromechanical devices 204. The processor-based electronic controller 200 may also communicate with a digital signal processor-based motor controller 206. The processor-based electronic controller 200 may receive inputs or data from the DSP-based motor controller 206, and the processor-based electronic controller 200 may command and control the DSP-based motor controller 206 in a master-slave relationship. The DSP-based motor controller 206 in turn controls an inverter and/or motor system 208. The inverter and/or motor system 208 may operate an electric motor, such as turning a washer drum, a dryer drum, or a compressor.

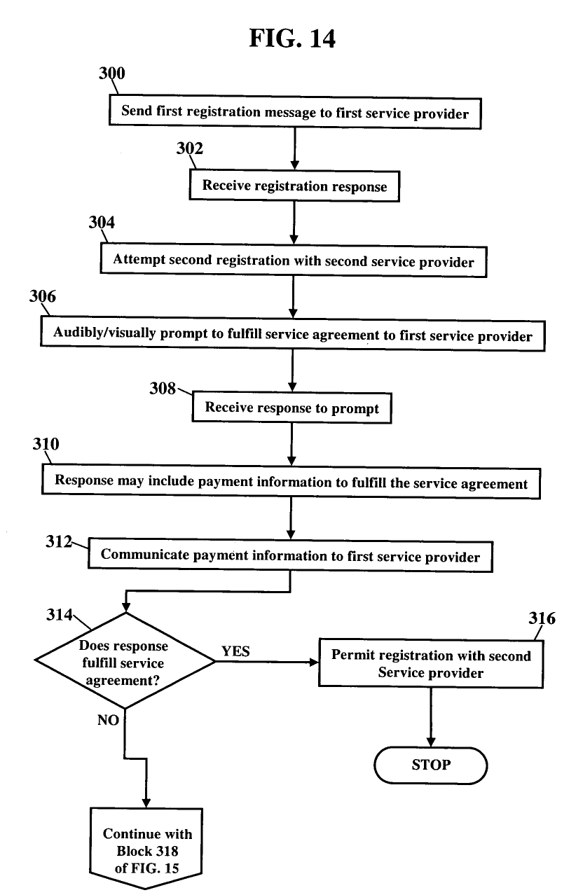

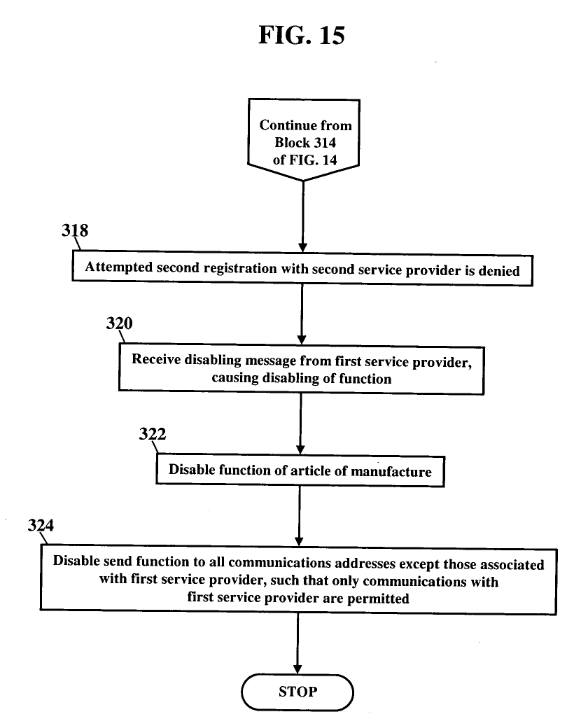

FIGS. 14 and 15 are flowcharts illustrating a method of remotely disabling an article of manufacture, according to exemplary embodiments. A first registration message is sent to a first service provider (Block 300). A registration response is received from the first service provider (Block 302), and the registration response confirms registration with the first service provider. A second registration is attempted with a second service provider (Block 304). A prompt is visually/audibly presented to fulfill a service agreement to the first service provider (Block 306). A response to the prompt is received (Block 308). The response may include payment information to fulfill the service agreement (Block 310). The payment information may be communicated to the first service provider (Block 312). If the response fulfills the service agreement (Block 314), then registration with the second service provider is permitted (Block 316).

The flowchart continues with FIG. 15. If the response fails to fulfill the service agreement (Block 314), then registration with the second service provider is denied (Block 318). A disabling message may be received from the first service provider (Block 320), and the disabling message causes disabling of a function of the article of manufacture. A processor may disable a function (Block 322). A send function may be disabled to all communications addresses except those communications addresses associated with the first service provider, such that only communications with the first service provider are permitted (Block 324).

The exemplary embodiments may be applied regardless of networking environment. The communications network 20 may be a cable network operating in the radio-frequency domain and/or the Internet Protocol (IP) domain. The communications network 20, however, may also include a distributed computing network, such as the Internet (sometimes alternatively known as the “World Wide Web”), an intranet, a local-area network (LAN), and/or a wide-area network (WAN). The communications network 20 may include coaxial cables, copper wires, fiber optic lines, and/or hybrid-coaxial lines. The communications network 20 may even include wireless portions utilizing any portion of the electromagnetic spectrum and any signaling standard (such as the I.E.E.E. 802 family of standards, GSM/CDMA/TDMA or any cellular standard, and/or the ISM band). The concepts described herein may be applied to any wireless/wireline communications network, regardless of physical componentry, physical configuration, or communications standard(s).

Exemplary embodiments may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of the exemplary embodiments, allow the calendaring application to be easily disseminated. A computer program product for remotely disabling an article of manufacture comprises a computer-readable medium storing computer code. The computer code performs the steps of sending a first registration message to a first service provider. A second registration with a second service provider is attempted. A prompt is visually/audibly produced to fulfill a service agreement to the first service provider. A response to the prompt is received. If the response fulfills the service agreement, then registration with the second service provider is permitted. If the response fails to fulfill the service agreement, then a function of the article of manufacture is disabled.

The exemplary embodiments may be applied to delinquent payment situations. The above paragraphs describe disablement for an exclusive service agreement. Yet the same concepts may be applied to subscribers who attempt to use their article of manufacture, despite delinquent payments on the service agreement. If the user's/subscriber's payment history is current, then the article of manufacture remains enabled for operation. If, however, the subscriber is delinquent, the article of manufacture may unilaterally disable functions until the user/subscriber is current. Likewise, the service provider may command disablement until payment is made.

While exemplary embodiments have been described with respect to various features, aspects, and embodiments, those skilled and unskilled in the art will recognize the exemplary embodiments is not so limited. Other variations, modifications, and alternative embodiments may be made without departing from the spirit and scope of the exemplary embodiments.

What is claimed is:

1. A device, comprising:
a processor communicating with a prompting device;
an interface for enabling communication between the processor and the prompting device;
the processor sends a first registration message to register with a first service provider;
the processor attempts a second registration with a second service provider;
the processor produces a prompt on the prompting device via the interface to fulfill an exclusive service agreement with the first service provider;
the processor receives a response to the prompt; and
if the response fulfills the service agreement, then the processor permits registration with the second service provider; or
if the response fails to fulfill the service agreement, then the processor disables a function of an article of manufacture.

2. A device according to claim 1, wherein the processor receives a registration response from the first service provider, the registration response confirming registration with the first service provider.

3. A device according to claim 1, wherein the processor denies registration with the second service provider.

4. A device according to claim 1, wherein the processor receives a disabling message from the first service provider, the disabling message instructing the processor to disable the function of the article of manufacture.

5. A device according to claim 1, wherein the response comprises payment information to fulfill the service agreement.

6. A device according to claim 5, wherein the processor communicates the payment information to the first service provider.

7. A device according to claim 1, wherein the processor disables a send function to all communications addresses except those addresses associated with the first service provider, such that the processor only permits communication with the first service provider.

8. A method of remotely disabling an article of manufacture, comprising:
sending a first registration message to a first service provider;
attempting a second registration with a second service provider;
prompting to fulfill a service agreement to the first service provider;
receiving a response to the prompt; and
if the response fulfills the service agreement, then permitting registration with the second service provider; or
if the response fails to fulfill the service agreement, then disabling a function of the article of manufacture.

9. A method according to claim 8, further comprising receiving a registration response from the first service provider, the registration response confirming registration with the first service provider.

10. A method according to claim 8, further comprising denying registration with the second service provider.

11. A method according to claim 8, further comprising receiving a disabling message from the first service provider, the disabling message causing the disabling of the function of the article of manufacture.

12. A method according to claim 8, wherein the step of receiving the response comprises receiving payment information to fulfill the service agreement.

13. A method according to claim 12, further comprising communicating the payment information to the first service provider.

14. A method according to claim 8, wherein the step of disabling the function of the article of manufacture comprises disabling a send function to all communications addresses except those communications addresses associated with the first service provider, such that only communications with the first service provider are permitted.

15. A computer program product for remotely disabling an article of manufacture, comprising:
a computer-readable medium storing computer code, the computer code performing the following steps:
sending a first registration message to a first service provider;
attempting a second registration with a second service provider;
prompting to fulfill a service agreement to the first service provider;
receiving a response to the prompt; and
if the response fulfills the service agreement, then permitting registration with the second service provider; or
if the response fails to fulfill the service agreement, then disabling a function of the article of manufacture.

16. A computer program product according to claim 15, further comprising computer code for receiving a registration response from the first service provider, the registration response confirming registration with the first service provider.

17. A computer program product according to claim 15, further comprising computer code for denying registration with the second service provider.

18. A computer program product according to claim 15, further comprising computer code for receiving a disabling message from the first service provider, the disabling message causing the disabling of the function of the article of manufacture.

19. A computer program product according to claim 15, wherein the step of receiving the response comprises receiving payment information to fulfill the service agreement, and further comprising computer code for communicating the payment information to the first service provider.

20. A computer program product according to claim 15, wherein the step of disabling the function of the article of manufacture comprises computer code for disabling a send function to all communications addresses except those communications addresses associated with the first service provider, such that only communications with the first service provider are permitted.
